(19) United States
(12) Patent Application Publication
(10) Pub. No.: US 2026/0153755 A1
(43) Pub. Date: Jun. 4, 2026

(54) INTERCONNECT SYSTEM FOR TRANSMITTING AND RECEIVING OPTICAL SIGNAL

(71) Applicant: SAMSUNG ELECTRONICS CO., LTD., Suwon-si (KR)

(72) Inventors: Hojung Kim, Suwon-si (KR); Kiho Kong, Suwon-si (KR)

(73) Assignee: SAMSUNG ELECTRONICS CO., LTD., Suwon-si (KR)

(21) Appl. No.: 19/197,347

(22) Filed: May 2, 2025

(30) Foreign Application Priority Data
Dec. 3, 2024 (KR) 10-2024-0177910

(51) Int. Cl. G02F 1/025; G02B 6/293; G02F 1/01

(52) U.S. Cl. CPC G02F 1/025; G02B 6/29338; G02F 1/0121; G02F 1/0147; G02F 2201/58; G02F 2203/15

(57) ABSTRACT

An interconnect system for transmitting an optical signal may include an electronic integrated circuit (EIC) configured to generate a driving signal, and a photonic integrated circuit (PIC). The PIC includes a drive circuit including a bipolar transistor to receive and amplify the driving signal, and a micro-ring modulator configured to generate the optical signal based on the amplified driving signal.

### CROSS-REFERENCE TO RELATED APPLICATION

This application is based on and claims priority under 35 U.S.C. Korean Patent Application No. 10-2024-0177910, filed on Dec. 3, 2024, in the Korean Intellectual Property Office, the disclosure of which is incorporated herein in its entirety by reference.

### BACKGROUND

### 1. Field

The disclosure relates to an interconnect system. More particularly, the disclosure relates to an interconnect system for transmitting, receiving, or transceiving an optical signal.

### 2. Description of the Related Art

Electrical signals are used in transmitting and receiving data of integrated circuits (IC). When voltage modulators generate voltage signals corresponding to data to be transmitted, transmitters transmit data through voltage signals. However, transmission methods based on electrical signals may have limitations in high-speed communications.

The use of optical signals is increasing for efficient data transmission and reception. Since optical signals provide wide bandwidth, low transmission loss, and fast transmission speed, optical signals are useful in data transmission. For efficient transmission and reception of the optical signals, configuring transceivers that effectively process electrical signals and optical signals is required.

### SUMMARY

One or more embodiments provide an interconnect system for transmitting and receiving an optical signal.

According to an aspect of the disclosure, an interconnect system for transmitting an optical signal includes an electronic integrated circuit (EIC) configured to generate a driving signal, and a photonic integrated circuit (PIC). The PIC includes a drive circuit including a bipolar transistor to receive and amplify the driving signal, and a micro-ring modulator configured to generate the optical signal based on the amplified driving signal.

According to another aspect of the disclosure, an interconnect system for transmitting and receiving an optical signal includes a transmitter and a receiver. The transmitter may include a first electronic integrated circuit (EIC) configured to generate a driving signal, and a first photonic integrated circuit (PIC) comprising a PIC drive circuit configured to amplify the driving signal, and a micro-ring modulator configured to generate the optical signal based on the amplified driving signal. The receiver may include a second PIC comprising a photodiode configured to receive the optical signal and a PIC sensing circuit configured to amplify an output signal of the photodiode and output the amplified output signal, and a second EIC configured to receive and process an output signal of the PIC sensing circuit of the second PIC.

According to another aspect of the disclosure, an interconnect system for receiving an optical signal includes a photonic integrated circuit (PIC) and an electronic integrated circuit (EIC). The PIC may include a photodiode configured to receive the optical signal, and a PIC sensing circuit comprising at least one of a bipolar transistor or a germanium thin film transistor (Ge TFT) to amplify an output signal of the photodiode and output the amplified output signal. The EIC may be configured to process an output signal of the PIC.

In an embodiment, the PIC drive circuit may be configured to amplify the driving signal to satisfy a voltage condition for driving the micro-ring modulator.

In an embodiment, the voltage condition for driving the micro-ring modulator may be satisfied when a peak-to-peak voltage is greater than 2 V.

In an embodiment, a peak-to-peak voltage of the driving signal received from the EIC may be less than 1 V.

In an embodiment, the EIC may be configured to process an electrical signal that has a peak-to-peak voltage less than 1 V.

In an embodiment, the PIC drive circuit and the micro-ring modulator may be manufactured in a single process.

In an embodiment, the PIC drive circuit may include at least one of a bipolar transistor or a germanium thin film transistor (Ge TFT).

In an embodiment, the photodiode may be configured to output an electrical signal that has a peak-to-peak current less than 100 μA.

In an embodiment, the PIC sensing circuit and the photodiode may be manufactured in a single process.

In an embodiment, the PIC sensing circuit may include at least one of a bipolar transistor and a Ge TFT.

In an embodiment, the PIC sensing circuit may be configured to amplify the output signal of the photodiode to output a voltage signal, and the second EIC may include a voltage amplifier configured to amplify the output signal of the PIC sensing circuit.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of a transmitter according to an embodiment;

FIG. 2 illustrates a circuit diagram of a transmitter according to an embodiment;

FIG. 3 illustrates a circuit diagram of a photonic integrated circuit (PIC) drive circuit according to an embodiment;

FIG. 4 illustrates a block diagram of a receiver according to an embodiment;

FIG. 5 illustrates a circuit diagram of a receiver according to an embodiment;

FIG. 6 illustrates a circuit diagram of a PIC sensing circuit according to an embodiment; and

FIGS. 7A, 7B, and 7C illustrate diagrams for explaining a manufacturing process of components according to some embodiments.

### DETAILED DESCRIPTION

Reference will now be made in detail to embodiments, examples of which are illustrated in the accompanying drawings, wherein like reference numerals refer to like elements throughout. In this regard, example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Terminologies used in the specification will be briefly described and the present embodiment will be described in detail. For example, the expression, “at least one of a, b, and c,” should be understood as including only a, only b, only c, both a and b, both a and c, both b and c, all of a, b, and c, or variations thereof. The singular forms are intended to include the plural forms as well, unless the context clearly indicates otherwise. Also, it should be understood that, when a part “comprises” or “includes” an element in the specification, unless otherwise defined, other elements are not excluded from the part and the part may further include other elements.

In the disclosure, an “interconnect system” may refer to a collection of electrical or optical circuits for transmitting, receiving, or transceiving optical signals. The interconnect system may include a transmitter, a receiver, or a transceiver.

In the disclosure, a photonic integrated circuit (PIC) may refer to an integrated circuit including photonic components. For example, the photonic components may include optical modulators or photodetectors.

In the disclosure, an electronic integrated circuit (EIC) may refer to an integrated circuit including electronic components. For example, an EIC may include passive elements or active elements.

An interconnect system may be included in an electronic device. An electronic device may be any of a variety of devices including at least one processor and memory, wherein at least one processor is configured to execute one or more instructions stored in the memory. For example, the electronic device may be, but is not limited to, a computer, a personal computer (PC), a laptop, a tablet, a smart device, a wearable device, a home appliance, an office electronic device, or an experimental electronic device. For example, the electronic device may be, but is not limited to, a device mounted on at least one of an automobile, an electric vehicle, an autonomous vehicle, an aircraft, a spacecraft, or a robot.

Hereinafter, various embodiments are described with reference to the accompanying drawings.

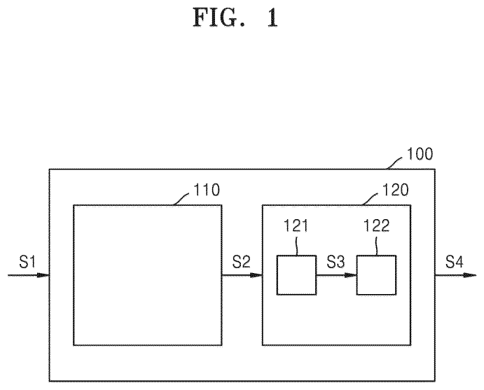

FIG. 1 illustrates a block diagram of a transmitter 100 according to an embodiment.

In an embodiment, an interconnect system for transmitting optical signals includes a transmitter 100. The transmitter 100 may receive an input signal S1 and generate an output signal S4 corresponding thereto. The input signal S1 may be an electrical signal corresponding to data to be sent. The output signal S4 may be an optical signal.

In an embodiment, the transmitter 100 includes an EIC 110 and a PIC 120. The PIC 120 includes a PIC drive circuit 121 and a micro-ring modulator 122.

The micro-ring modulator 122 may be configured to perform optical modulation by adjusting a resonance phase in response to a driving signal (i.e., an input voltage). The micro-ring modulator 122 is a high-speed electro-optic modulator that may efficiently transmit optical signals with high throughput.

The EIC 110 may be configured to process an input signal S1. For example, the EIC 110 may be configured to perform serialization and equalization on the input signal S1, but is not limited thereto.

The EIC 110 may generate a driving signal S2 for driving the micro-ring modulator 122 based on the input signal S1 and transmit the driving signal S2 to the PIC 120. In an embodiment, the EIC 110 may include an EIC drive circuit for generating a driving signal S2. In an embodiment, the EIC drive circuit may be implemented without an amplifier, or such that the input signal and the output signal have the same peak-to-peak voltage.

The PIC drive circuit 121 may generate an amplified driving signal S3 by amplifying the driving signal S2. In detail, the PIC drive circuit 121 may amplify the driving signal S2 to satisfy the voltage conditions for driving the micro-ring modulator 122. In an embodiment, a peak-to-peak voltage that is required to drive the micro-ring modulator 122 is greater than 2 V, and accordingly, the peak-to-peak voltage of the amplified driving signal S3 may be greater than 2 V.

Since the PIC drive circuit 121 of the PIC 120 is configured to amplify the driving signal S2, the EIC 110 may be designed to be free from the voltage condition for driving the micro-ring modulator 122. In an embodiment, the EIC 110 may be configured to process an electrical signal having a peak-to-peak voltage of less than 1 V. This provides a similar level of design freedom as other electronic transmitters, which are generally configured to process electrical signals of less than 1 V.

Since the PIC drive circuit 121 of the PIC 120 is configured to amplify the driving signal S2, the driving signal S2 having a relatively low peak-to-peak voltage may be transmitted from the EIC 110 to the PIC 120. In an embodiment, the peak-to-peak voltage of the driving signal S2 may be less than 1 V. A high voltage signal may be greatly affected by parasitic loads or noise between the EIC 110 and the PIC 120. However, the low peak-to-peak voltage of the driving signal S2 may reduce the above effect, thereby enabling effective signal transmission.

In an embodiment, the PIC drive circuit 121 may be implemented as a bipolar transistor. The PIC drive circuit 121 may be implemented as an NPN bipolar transistor or a PNP bipolar transistor. The PIC drive circuit 121 may not include a metal-oxide-semiconductor field-effect transistor (MOSFET).

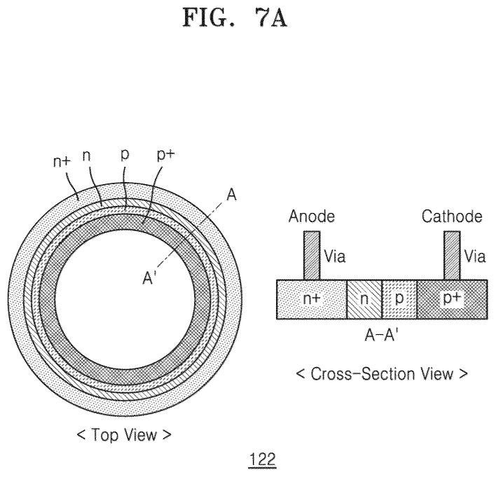

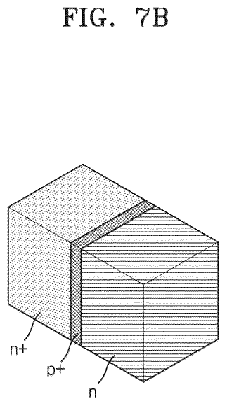

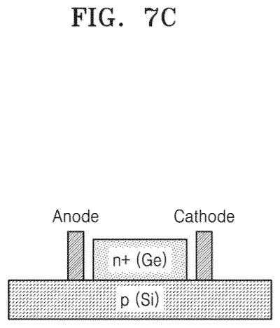

In an embodiment, as illustrated in FIG. 7A, the micro-ring modulator 122 may be implemented as an n-type semiconductor and a p-type semiconductor. The PIC drive circuit 121 may also be implemented as an n-type semiconductor and a p-type semiconductor. For example, as illustrated in FIG. 7B, the PIC drive circuit 121 may be implemented as an NPN transistor.

Since both the micro-ring modulator 122 and the PIC drive circuit 121 may be implemented as an n-type semiconductor and a p-type semiconductor, the PIC drive circuit 121 and the micro-ring modulator 122 may be manufactured together in a single process (i.e., a single manufacturing process). Here, a single process refer to a fabrication of the micro-ring modulator 122 and the PIC drive circuit 121 in one manufacturing step. That is, the PIC 120 may be manufactured by forming the PIC drive circuit 121 and the micro-ring modulator 122 together in a single process. Since the PIC drive circuit 121 and the micro-ring modulator 122 are manufactured in a single process, process consistency of the PIC 120 may be improved, thereby improving performance of the PIC 120.

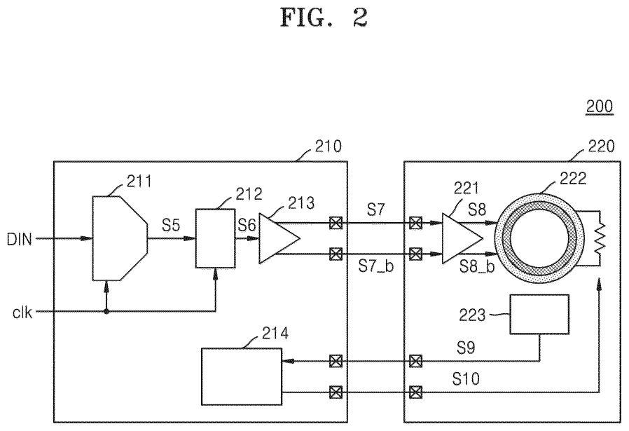

FIG. 2 illustrates a circuit diagram of a transmitter 200 according to an embodiment.

The transmitter 200 may be configured to transmit an optical signal corresponding to input data DIN. In an embodiment, the transmitter 200 includes an EIC 210 and a PIC 220.

In an embodiment, the EIC 210 includes a serializer 211, an equalizer 212, an EIC drive circuit 213, and a temperature control unit (TCU) 214. The PIC 220 includes a PIC drive circuit 221, a micro-ring modulator 222, and a photodiode 223. In some embodiments, components of the EIC 210 and PIC 220 may be omitted or added.

The serializer 211 may serialize input data DIN. For example, the serializer 211 may serialize 16-bit parallel data, but the size of the parallel data is not limited thereto.

The equalizer 212 may receive serialized input data as an input signal S5. The equalizer 212 may equalize the input signal S5 based on a clock signal clk. For example, the equalizer 212 may be a feed forward equalizer (FFE).

The EIC drive circuit 213 may receive serialized and equalized input data as an input signal S6. The EIC drive circuit 213 may generate a driving signal S7 for driving the micro-ring modulator 222 in response to the input signal S6.

The EIC drive circuit 213 may be implemented as a field-effect transistor (FET). In an embodiment, the EIC drive circuit 213 may not include an amplifier. As a result, the EIC drive circuit 213 may preserve a peak-to-peak signal of the input signal S6 in the output signal S7.

The EIC 210 may be configured to process electrical signals having a peak-to-peak voltage of less than 1 V. Additionally, since the EIC drive circuit 213 does not include an amplifier, the peak-to-peak voltage of the driving signal S7 may be less than 1 V.

The PIC drive circuit 221 may include an amplifier. The PIC drive circuit 121 may generate an amplified driving signal S8 by amplifying the driving signal S7. The amplified driving signal S8 may satisfy a voltage condition for driving the micro-ring modulator 222. The EIC 210 may operate in a peak-to-peak voltage range that is lower than a peak-to-peak voltage range required to drive the micro-ring modulator 222, since the PIC 220 includes the PIC drive circuit 221 configured to amplify the output signal S7 to meet the required peak-to-peak voltage range for the micro-ring modulator 222. If the required peak-to-peak voltage range for the micro-ring modulator 222 is k, and the gain of the PIC drive circuit 221 is g, the peak-to-peak voltage range of the EIC 210 may be k/g. For example, the voltage condition for driving the micro-ring modulator 222 is that the peak-to-peak voltage is greater than 2 V, and, to satisfy the voltage condition, the peak-to-peak voltage of the output signal S8 and an inverted output signal S8_b may be greater than 2 V.

The peak-to-peak voltage of the output signal S8 and the inverted output signal S8_b may be at least two times greater than the peak-to-peak voltage of the input signal S7 and an inverted input signal S7_b. In other words, since the PIC drive circuit 221 includes an amplifier, the driving signal S7 transmitted from the EIC 210 to the PIC 220 may have a voltage that is at least two times less than when the PIC drive circuit 221 does not include an amplifier. The driving signal S7 of a low voltage may be less affected by parasitic loads or noise between the EIC 210 and the PIC 220.

The photodiode 223 and the TCU 214 may operate to control the temperature of the micro-ring modulator 222. The photodiode 223 may transmit a signal S9 indicating the temperature of the micro-ring modulator 222 to the 214. The TCU 214 may generate a signal S10 for controlling the temperature of the micro-ring modulator 222 based on the signal S9. The temperature of the micro-ring modulator 222 may be controlled by changing a resistance connected to the micro-ring modulator 222 according to the signal S10.

In an embodiment, as illustrated in FIG. 7C, the PIC drive circuit 221 may be implemented as a germanium (Ge) thin-film transistor (TFT). In an embodiment, the photodiode 223 may be a Ge photodiode and the PIC drive circuit 221 may also be implemented as a germanium thin film transistor (Ge TFT). Accordingly, the PIC drive circuit 221 and the photodiode 223 may be simultaneously manufactured in a single process (i.e., a single manufacturing process). Here, a single process means that the PIC drive circuit 221 and the photodiode 223 may be manufactured simultaneously or together in a single process. Since the PIC drive circuit 221 and the photodiode 223 are manufactured in a single process, process consistency of the PIC 220 may be improved, thereby improving performance of the PIC 220.

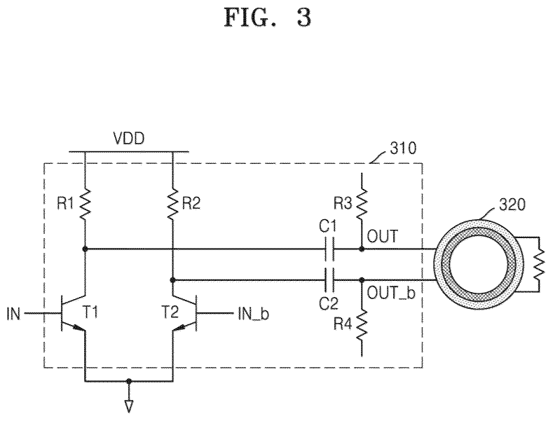

FIG. 3 illustrates a circuit diagram of a PIC drive circuit 310 according to an embodiment.

The PIC drive circuit 310 may be configured to amplify an input signal IN and generate an output signal OUT. The PIC drive circuit 310 may be implemented as an n-type semiconductors and a p-type semiconductor in the same manufacturing process as a micro-ring modulator 320. For example, the PIC drive circuit 310 may be implemented as various circuits by using an NPN bipolar transistor or a PNP bipolar transistor.

Referring to FIG. 3, the PIC drive circuit 310 implemented as NPN bipolar transistors according to an embodiment is illustrated. The PIC drive circuit 310 includes resistors R1 to R4 (hereinafter, also referred to as first to fourth resistors R1 to R4), capacitors C1 and C2, and NPN bipolar transistors T1 and T2.

The first and second resistors R1 and R2 and the NPN bipolar transistors T1 and T2 may amplify the peak-to-peak voltage of the input signal IN and an input signal bar IN_b. The inverted output signal OUT_b may be generated by eliminating a DC component from the amplified signals through the capacitors C1 and C2 and setting baseline voltages of the amplified signals through the third and fourth resistors R3 and R4.

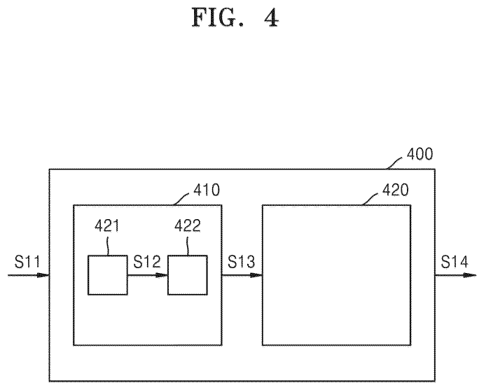

FIG. 4 illustrates a block diagram of a receiver 400 according to an embodiment.

In an embodiment, an interconnect system for receiving optical signals includes the receiver 400. The receiver 400 may receive an input signal S11 and generate an output signal S14 corresponding thereto. The input signal S11 may be an optical signal with encoded data. The output signal S14 may be an electrical signal.

In an embodiment, the receiver 400 includes a PIC 410 and an EIC 420. The PIC 410 includes a photodiode 421 and a PIC sensing circuit 422.

The photodiode 421 is an opto-electronic modulator that may generate an electrical output signal S12 corresponding to the optical input signal S11. The photodiode 421 may directly receive the input signal S11 or receive the input signal S11 passed through a filter. For example, the filter may be a microwave bandpass filter.

The output signal S12 of the photodiode 421 may be detected or sensed by the PIC sensing circuit 422. If the output signal S12 of the photodiode 421 were only detected by the EIC 420, parasitic load or noise between the PIC 410 and the EIC 420 could limit the bandwidth of the signal, resulting in a low signal-to-noise ratio (SNR). In addition, high performance of the photodiode 421 is required to secure high SNR. However, by detecting the output signal S12 of the photodiode 421 through the PIC sensing circuit 422 arranged in the PIC 410, the influence of parasitic load and noise on the signal may be reduced, enabling the signal to be detected with a higher SNR. In addition, the circuit configuration and arrangement in the embodiment may eliminate the need for a high performance photodiode, allowing for the use of the photodiode 421 that produces the output signal S12 with a low peak-to-peak current. In an embodiment, the peak-to-peak current of the output signal S12 may be less than 100 μA. Compared to other electronic receivers that include photodiodes typically generating electrical signals greater than 100 μA, the photodiode 421 in the embodiment may experience a reduced burden.

In an embodiment, the PIC sensing circuit 422 may be implemented as a Ge TFT. In an embodiment, the photodiode 421 may be a Ge photodiode and the PIC sensing circuit 422 may also be implemented as a Ge TFT. Accordingly, the PIC sensing circuit 422 and the photodiode 421 may be manufactured in a single process (i.e., a single manufacturing process). Here, a single process means that the PIC sensing circuit 422 and the photodiode 421 may be manufactured simultaneously or together in a single process. That is, the PIC 421 may be manufactured by forming the PIC sensing circuit 422 and the photodiode 421 simultaneously or together in a single process. Since the PIC sensing circuit 422 and the photodiode 421 are manufactured in a single process, process consistency of the PIC 410 may be improved, thereby improving performance of the PIC 410.

In an embodiment, both the photodiode 421 and the PIC sensing circuit 422 may be implemented as an n-type semiconductor and a p-type semiconductor. Accordingly, the PIC sensing circuit 422 and the photodiode 421 may be manufactured in a single process. Since the PIC sensing circuit 422 and the photodiode 421 are manufactured in a single process, process consistency of the PIC 410 may be improved, thereby improving performance of the PIC 410.

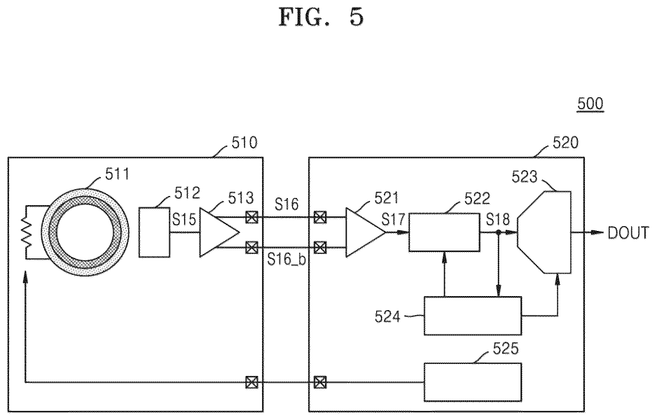

FIG. 5 is a circuit diagram of a receiver 500 according to an embodiment.

The receiver 500 may be configured to generate output data DOUT corresponding to a received optical signal. In an embodiment, the receiver 500 includes a PIC 510 and an EIC 520.

In an embodiment, the PIC 510 includes a micro-ring modulator 511, a photodiode 512, and a PIC sensing circuit 513. The EIC 520 includes an EIC sensing circuit 521, an equalizer 522, a deserializer 523, a clock data recovery circuit (CDR) 524, and a temperature control device 525. In some embodiments, components of the PIC 510 and EIC 520 may be omitted or added.

A photodiode 521 may receive an optical signal and generate an electrical signal S15 corresponding to the received optical signal. The micro-ring modulator 511 may operate as a microwave bandpass filter, and the photodiode 521 may receive an optical signal passed through the filter.

The PIC sensing circuit 513 may include an amplifier. The PIC sensing circuit 513 is a sense amplifier and may generate an amplified output signal S16. Since the PIC sensing circuit 513 is configured to amplify the output signal S15 of the photodiode 521, the photodiode 421 having an output signal S15 of low peak-to-peak current may be used.

The EIC sensing circuit 521 may be configured to amplify the output signal S16 of the PIC sensing circuit 513. In an embodiment, the EIC sensing circuit 521 may be implemented as a FET. For example, the EIC sensing circuit 521 may be, but is not limited to, a differential amplifier.

The equalizer 522 may equalize an input signal S17 based on a clock signal recovered by the CDR 524. For example, the equalizer 212 may be, but is not limited to, a decision feedback equalizer (DFE).

The deserializer 523 may deserialize an input signal S18 to generate output data DOUT. For example, the deserializer 523 may deserialize 16-bit parallel data, but the size of the parallel data is not limited thereto.

The temperature control device 525 may control a temperature of the micro-ring modulator 511.

In an embodiment, the PIC sensing circuit 513 may be implemented as a bipolar transistor. The PIC sensing circuit 513 may be implemented as an NPN bipolar transistor or a PNP bipolar transistor. The PIC sensing circuit 513 may not include a MOSFET.

In an embodiment, since the micro-ring modulator 511 may be implemented as an n-type semiconductor and a p-type semiconductor, and the PIC sensing circuit 513 may also be implemented as an n-type semiconductor and a p-type semiconductor, the PIC sensing circuit 513 and the micro-ring modulator 511 may be manufactured in a single process. Since the PIC sensing circuit 513 and the micro-ring modulator 511 are manufactured in a single process, process consistency of the PIC 510 may be improved, thereby improving performance of the PIC 510.

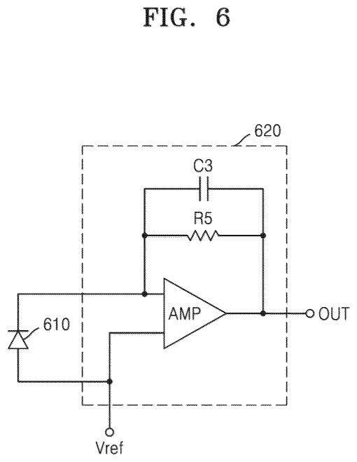

FIG. 6 is a circuit diagram of a PIC sensing circuit 620 according to an embodiment.

The PIC sensing circuit 620 may be configured to amplify an output of a photodiode 610 to generate an output signal OUT. The PIC sensing circuit 620 may be implemented as a Ge TFT, an n-type semiconductor, or a p-type semiconductor in the same manufacturing process as the photodiode 610. For example, the PIC sensing circuit 620 may be implemented as various circuits by using an NPN bipolar transistor, a PNP bipolar transistor, or Ge TFT.

FIG. 6 shows a PIC sensing circuit 620 implemented as a transimpedance amplifier (TIA) according to an embodiment. The PIC sensing circuit 620 includes a resistor R5, a capacitor C3, and an amplifier AMP.

The PIC sensing circuit 620 may amplify an output current of the photodiode 610 to generate a voltage signal. In the PIC sensing circuit 620, the capacitor C3 may be used for stability and the resistor R5 may be used for DC gain.

The interconnect system for transmitting and receiving optical signals may include the transmitter and the receiver as described by the above embodiments.

In the above embodiments, other types of optical modulators may be used instead of the micro-ring modulator. Additionally, other types of photodetectors may be used instead of the photodiode.

Embodiment 1: A method of manufacturing an interconnect system for transmitting an optical signal may include manufacturing a PIC by forming a micro-ring modulator and a PIC drive circuit for amplifying a drive signal for the micro-ring modulator through a single process, and manufacturing an EIC for generating the drive signal, wherein the manufacturing of the PIC may include forming the PIC drive circuit with a bipolar transistor.

Embodiment 2: In the method of manufacturing the interconnect system for transmitting the optical signal of Embodiment 1, the manufacturing of the PIC may further include forming the micro-ring modulator and the PIC drive circuit with n-type semiconductors and p-type semiconductors through the single process.

Embodiment 3: A method of manufacturing an interconnect system for receiving an optical signal may include manufacturing a PIC by forming a photodiode and a PIC sensing circuit for amplifying an output signal of the photodiode through a single process, and manufacturing an EIC for processing an output signal of the PIC, wherein the manufacturing of the PIC may include forming the PIC sensing circuit with at least one of a bipolar transistor or a Ge TFT.

Embodiment 4: In the method of manufacturing the interconnect system for receiving the optical signal of Embodiment 3, the manufacturing of the PIC may further include forming the photodiode and the PIC sensing circuit with at least one of an n-type semiconductor, a p-type semiconductor, or a Ge TFT through the single process.

Embodiment 5: In a method of operating an interconnect system for transmitting an optical signal, the interconnect system may include a PIC including a micro-ring modulator and a PIC drive circuit and an EIC, wherein the method of operating the interconnect system for transmitting the optical signal may include transmitting a driving signal to the PIC by the EIC, amplifying the driving signal by the PIC drive circuit, and outputting an optical signal by the micro-ring modulator based on the amplified driving signal.

Embodiment 6: In the method of operating an interconnect system for transmitting the optical signal of Example 5, the amplifying of the driving signal may satisfy a voltage condition for driving the micro-ring modifier.

Embodiment 7: In a method of operating an interconnect system for receiving an optical signal, the interconnect system may include a photonic integrated circuit including a photodiode and a PIC sensing circuit and an EIC, and the method of operating the interconnect system for receiving the optical signal may include generating an electrical signal corresponding to an optical signal received by the photodiode, amplifying the electrical signal by the PIC sensing circuit, and processing the amplified electrical signal by the EIC.

Embodiment 8: An electronic device may include an interconnect system for transmitting an optical signal, wherein the interconnect system may include a PIC including a micro-ring modulator for transmitting an optical signal and an EIC for driving the PIC, the PIC may be configured to receive a driving signal for driving the micro-ring modulator from the EIC and further include a PIC drive circuit configured to amplify the driving signal, and the PIC drive circuit may be implemented as a bipolar transistor.

Embodiment 9: An electronic device may include an interconnect system for transmitting and receiving an optical signal, wherein the interconnect system may include a first PIC including a micro-ring modulator for transmitting an optical signal, a transmitter including a first EIC for driving the first PIC, a second PIC including a photodiode for receiving an optical signal, and a receiver including a second EIC for processing an output signal of the second PIC, wherein the first PIC may be configured to receive a driving signal for driving the micro-ring modulator from the first EIC and include a PIC drive circuit configured to amplify the driving signal, and the second PIC may include a PIC sensing circuit configured to amplify an output signal of the photodiode and may be configured to transmit the output signal of the PIC sensing circuit to the second EIC.

Embodiment 10: An electronic device may include an interconnect system for receiving an optical signal, wherein the interconnect system may include a PIC including a photodiode for receiving an optical signal and an EIC for processing an output signal of the PIC, the PIC may include a PIC sensing circuit configured to amplify an output signal of the photodiode and may be configured to transmit an output signal of the PIC sensing circuit to the EIC, and the PIC sensing circuit may be implemented as a bipolar transistor or a GeTFT.

As described above, embodiments have been disclosed in the drawings and specification.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An interconnect system for transmitting an optical signal, the interconnect system comprising:
an electronic integrated circuit (EIC) configured to generate a driving signal; and
a photonic integrated circuit (PIC) comprising:
a PIC drive circuit comprising a bipolar transistor to receive and amplify the driving signal; and
a micro-ring modulator configured to generate the optical signal based on the amplified driving signal.

2. The interconnect system of claim 1, wherein the PIC drive circuit is configured to amplify the driving signal to satisfy a voltage condition for driving the micro-ring modulator.

3. The interconnect system of claim 2, wherein the voltage condition for driving the micro-ring modulator is satisfied when a peak-to-peak voltage is greater than 2 V.

4. The interconnect system of claim 1, wherein a peak-to-peak voltage of the driving signal received from the EIC is less than 1 V.

5. The interconnect system of claim 1, wherein the EIC is further configured to process an electrical signal that has a peak-to-peak voltage less than 1 V.

6. The interconnect system of claim 1, wherein the PIC drive circuit and the micro-ring modulator are manufactured in a single process.

7. An interconnect system for transmitting and receiving an optical signal, the interconnect system comprising:
a transmitter comprising:
a first electronic integrated circuit (EIC) configured to generate a driving signal; and
a first photonic integrated circuit (PIC) comprising a PIC drive circuit configured to amplify the driving signal, and a micro-ring modulator configured to generate the optical signal based on the amplified driving signal;
a receiver comprising:
a second PIC comprising a photodiode configured to receive the optical signal and a PIC sensing circuit configured to amplify an output signal of the photodiode and output the amplified output signal; and
a second EIC configured to receive and process an output signal of the PIC sensing circuit of the second PIC.

8. The interconnect system of claim 7, wherein the PIC drive circuit is further configured to amplify the driving signal to satisfy a voltage condition for driving the micro-ring modulator.

9. The interconnect system of claim 8, wherein the voltage condition for driving the micro-ring modulator is satisfied when a peak-to-peak voltage is greater than 2 V.

10. The interconnect system of claim 7, wherein a peak-to-peak voltage of the driving signal received from the EIC is less than 1 V.

11. The interconnect system of claim 7, wherein the EIC is configured to process an electrical signal of which a peak-to-peak voltage is less than 1 V.

12. The interconnect system of claim 7, wherein the PIC drive circuit and the micro-ring modulator are manufactured in a single process.

13. The interconnect system of claim 7, wherein the PIC drive circuit comprises at least one of a bipolar transistor or a germanium thin film transistor (Ge TFT).

14. The interconnect system of claim 7, wherein the photodiode is further configured to output an electrical signal that has a peak-to-peak current less than 100 μA.

15. The interconnect system of claim 7, wherein the PIC sensing circuit and the photodiode are manufactured in a single process.

16. The interconnect system of claim 7, wherein the PIC sensing circuit comprises at least one of a bipolar transistor or a germanium thin film transistor (Ge TFT).

17. The interconnect system of claim 7, wherein
the PIC sensing circuit is further configured to amplify the output signal of the photodiode to output a voltage signal, and
the second EIC comprises a voltage amplifier configured to amplify the output signal of the PIC sensing circuit.

18. An interconnect system for receiving an optical signal, the interconnect system comprising:
a photonic integrated circuit (PIC) comprising a photodiode configured to receive the optical signal, and a PIC sensing circuit comprising at least one of a bipolar transistor or a germanium thin film transistor (Ge TFT) to amplify an output signal of the photodiode and output the amplified output signal; and
an electronic integrated circuit (EIC) configured to process an output signal of the PIC.

19. The interconnect system of claim 18, wherein the PIC sensing circuit and the photodiode are manufactured in a single process.

20. The interconnect system of claim 18, wherein
the PIC sensing circuit is further configured to amplify the output signal of the photodiode to output a voltage signal, and
the EIC comprises a voltage amplifier configured to amplify the output signal of the PIC sensing circuit.
